(19) United States
(12) Patent Application Publication
(10) Pub. No.: US 2016/0303620 A1
(43) Pub. Date: Oct. 20, 2016

(54) APPARATUS FOR MANUFACTURING ELECTRONIC DEVICE, CLEANING METHOD, AND METHOD OF MANUFACTURING ELECTRONIC DEVICE USING THE CLEANING METHOD

(71) Applicants: Do-hoon KIM, Suwon-si (KR); Won-woong CHUNG, Suwon-si (KR)

(72) Inventors: Do-hoon KIM, Suwon-si (KR); Won-woong CHUNG, Suwon-si (KR)

(21) Appl. No.: 14/989,046

(22) Filed: Jan. 6, 2016

(30) Foreign Application Priority Data
Apr. 16, 2015 (KR) 10-2015-0053773

(51) Int. Cl. B08B 9/08; C11D 7/02; C11D 11/00

(52) U.S. Cl. CPC B08B 9/08; C11D 11/0041; C11D 7/02

(57) ABSTRACT

An apparatus for manufacturing an electronic device, including a chamber; and a supply line supplying cleaning gas to an inside of the chamber, the apparatus cleaning the inside of the chamber using the cleaning gas including diatomic molecules that are heteronuclear molecules containing a halogen element, while the inside of the chamber is maintained at a temperature of about 400° C. to about 1000° C.

### CROSS-REFERENCE TO RELATED APPLICATION

Korean Patent Application No. 10-2015-0053773, filed on Apr. 16, 2015, in the Korean Intellectual Property Office, and entitled: “Apparatus for Manufacturing Electronic Device, Cleaning Method, and Method of Manufacturing Electronic Device Using the Cleaning Method,” is incorporated by reference herein in its entirety.

### BACKGROUND

Embodiments relate to an apparatus for manufacturing an electronic device (hereinafter, referred to as an electronic device manufacturing apparatus), a cleaning method, and a method of manufacturing an electronic device using the cleaning method.

### SUMMARY

Embodiments may be realized by providing an apparatus for manufacturing an electronic device, including a chamber; and a supply line supplying cleaning gas to an inside of the chamber, the apparatus cleaning the inside of the chamber using the cleaning gas including diatomic molecules that are heteronuclear molecules containing a halogen element, while the inside of the chamber is maintained at a temperature of about 400° C. to about 1000° C.

The apparatus may vaporize a metal or a metal-containing material contained in the chamber using the diatomic molecules to clean the inside of the chamber.

The chamber may form a thin film including a metal, a metal nitride, a metal oxide, silicon oxide, silicon nitride, a semiconductor, or a combination thereof on a substrate.

The apparatus may cause a reaction of the diatomic molecules with titanium or a titanium-containing material contained in the chamber to clean the inside of the chamber.

The diatomic molecules may include a first atom and a halogen element, and the electronic device manufacturing apparatus may cause a reaction such that the first atom and the halogen element respectively combine with the titanium or the titanium-containing material to clean the inside of the chamber.

The apparatus may deposit a metal-containing material in the chamber while forming a thin film on a substrate in the chamber maintained at a temperature of at least about 500° C. before the inside of the chamber is cleaned, and may supply the cleaning gas into the chamber and may remove the metal-containing material from the inside of the chamber after the substrate on which the thin film is formed is unloaded from the chamber, to clean the inside of the chamber.

The apparatus may vaporize the metal-containing material by a reaction of the diatomic molecules with the metal-containing material and may discharge the vaporized resultant from the chamber to clean the inside of the chamber.

The cleaning gas may include chlorine monofluoride.

The cleaning gas may include chlorine monofluoride and at least one inactive gas.

The cleaning gas may include a first gas including chlorine monofluoride; and a second gas including a hydrocarbon compound, a fluorine-containing material, a chlorine-containing material, a nitrogen-containing material, an oxygen-containing material, an inactive gas, or a combination thereof.

Embodiments may be realized by providing a cleaning method, including supplying to an inside of a chamber a cleaning gas containing diatomic molecules that are heteronuclear molecules containing a halogen element; and cleaning the inside of the chamber using the cleaning gas while the inside of the chamber is maintained at a temperature of about 400° C. to about 1000° C.

The diatomic molecules may include a first atom and a halogen element, and bond energy between the first atom and the halogen element may be at least 200 KJ/mol.

The diatomic molecules may be chlorine monofluoride.

Cleaning the inside of the chamber may include supplying the diatomic molecules and at least one inactive gas into the chamber.

The cleaning gas may include a first reactive gas including the diatomic molecules containing a first atom and a second atom; a second reactive gas including molecules that contain at least one of the first atom and the second atom and have a different chemical formula from the diatomic molecules; and an inactive gas.

The cleaning gas may include a first reactive gas including the diatomic molecules containing a first atom and a second atom; a second reactive gas including a third atom that is different from the first atom and the second atom; and an inactive gas.

The cleaning gas may include a first gas including the diatomic molecules; and a second gas including a hydrocarbon compound, a fluorine-containing material, a chlorine-containing material, a nitrogen-containing material, an oxygen-containing material, an inactive gas, or a combination thereof.

Cleaning the inside of the chamber may include vaporizing a metal or a metal-containing material contained in the chamber, using the diatomic molecules.

Cleaning the inside of the chamber may include causing a reaction of the diatomic molecules with titanium or a titanium-containing material contained in the chamber.

The diatomic molecules may include a first atom and a halogen element, and cleaning the inside of the chamber may include causing a reaction such that the first atom and the halogen element respectively combine with titanium or a titanium-containing material to vaporize titanium or the titanium-containing material.

The chamber may include at least one constituent element containing an aluminum-containing material, and cleaning the inside of the chamber may include bringing the diatomic molecules into contact with the at least one constituent element.

A susceptor and an inner sidewall of the chamber may be exposed in the chamber, and cleaning the inside of the chamber may include bringing the diatomic molecules into contact with the susceptor and the inner sidewall of the chamber while the susceptor is maintained at a first temperature selected in the range of about 400° C. to about 1000° C. and the inner sidewall of the chamber is maintained at a second temperature lower than the first temperature.

Embodiments may be realized by providing a cleaning method, including supplying a cleaning gas including diatomic molecules that are heteronuclear molecules containing a first atom and a halogen element into a chamber; and causing a reaction of the diatomic molecules with a metal-containing contaminant adsorbed to an inside of the chamber to vaporize the metal-containing contaminant.

An aluminum-containing constituent element may be contained in the chamber, and vaporizing the metal-containing contaminant may include supplying the diatomic molecules to a surface of the constituent element.

During supplying the cleaning gas into the chamber and vaporizing the metal-containing contaminant, at least a portion of the inside of the chamber may be maintained at a temperature of about 400° C. to about 1000° C.

The chamber may include a susceptor supporting a substrate in the chamber, and the susceptor may be maintained at a temperature of about 400° C. to about 1000° C. during supplying the cleaning gas into the chamber and vaporizing the metal-containing contaminant.

The cleaning gas may include chlorine monofluoride.

The cleaning gas may include chlorine monofluoride and an inactive gas.

The cleaning gas may include chlorine monofluoride; and at least one of a hydrocarbon compound, a fluorine-containing material, a chlorine-containing material, a nitrogen-containing material, an oxygen-containing material, or a combination thereof.

The metal-containing contaminant may include titanium.

Embodiments may be realized by providing a method of manufacturing an electronic device, the method including forming a thin film on a first substrate in the chamber while a metal-containing material is deposited in at least a portion of an inside of the chamber; unloading the first substrate on which the thin film is formed, from the chamber; and supplying a cleaning gas including diatomic molecules that are heteronuclear molecules containing a halogen element into the chamber to remove the metal-containing material from the inside of the chamber.

Removing the metal-containing material may include vaporizing the metal-containing material by a reaction of the diatomic molecules with the metal-containing material; and discharging a vaporized resultant from the chamber.

The inside of the chamber may be maintained in a vacuum state from when forming the thin film on the first substrate has started to until removing the metal-containing material is ended.

Forming the thin film on the first substrate may include forming a titanium-containing thin film on the first substrate, and removing the metal-containing material may include generating a first reaction resultant by a reaction of a first atom forming the diatomic molecules with titanium and generating a second reaction resultant by a reaction of a second atom forming the diatomic molecules with titanium.

The first reaction resultant and the second reaction resultant may be simultaneously generated.

Forming the thin film on the first substrate may include maintaining the first substrate at a first temperature, and removing the metal-containing material may include supplying the cleaning gas into the chamber while at least a portion of the inside of the chamber is maintained at a second temperature in a range of the first temperature ±100° C.

The cleaning gas may include chlorine monofluoride.

The cleaning gas may include a first reactive gas including chlorine monofluoride; and at least one gas of a second reactive gas including molecules having a different chemical formula from the diatomic molecules and an inactive gas.

Forming the thin film on the first substrate may include forming a thin film including a metal, a metal nitride, a metal oxide, silicon oxide, silicon nitride, a semiconductor, or a combination thereof on the first substrate.

Forming the thin film on the first substrate may be performed using a chemical vapor deposition process, an atomic layer deposition process, or a physical vapor deposition process.

The method may further include, after removing the metal-containing material from the inside of the chamber, loading a second substrate into the chamber; and forming a thin film on the second substrate in the chamber.

Embodiments may be realized by providing a method of manufacturing an electronic device, the method including forming a titanium-containing film on a substrate in a chamber of an apparatus at a deposition temperature, the apparatus further including a susceptor supporting the substrate, one or more of an inner wall of the chamber or the susceptor including an aluminum-containing material; unloading the substrate from the chamber; performing an in-situ cleaning process in the chamber, including supplying chlorine monofluoride into the chamber; and vaporizing titanium or a titanium-containing material from the inner wall of the chamber or the susceptor by reaction with the chlorine monofluoride, the vaporizing being performed at a temperature not less than 100° C. less than the deposition temperature; and discharging the vaporized titanium or titanium-containing material from the chamber.

### BRIEF DESCRIPTION OF THE DRAWINGS

Features will become apparent to those of skill in the art by describing in detail exemplary embodiments with reference to the attached drawings in which:

FIG. 1 illustrates a flowchart of a cleaning method according to exemplary embodiments;

FIG. 2 illustrates a schematic cross-sectional view of a chamber to which a cleaning method may be applied according to exemplary embodiments;

FIG. 3 illustrates a flowchart of a cleaning method according to other exemplary embodiments;

FIG. 4 illustrates a schematic diagram of a configuration of an electronic device manufacturing apparatus to which a cleaning method may be applied, according to exemplary embodiments;

FIG. 5 illustrates a schematic diagram of a configuration of another electronic device manufacturing apparatus to which a cleaning method may be applied, according to exemplary embodiments;

FIGS. 6A and 6B illustrate schematic diagrams of a configuration of another electronic device manufacturing apparatus to which a cleaning method may be applied, according to exemplary embodiments;

FIG. 7 illustrates a schematic diagram of a configuration of another electronic device manufacturing apparatus to which a cleaning method may be applied, according to exemplary embodiments;

FIG. 8 illustrates a flowchart of a method of manufacturing an electronic device according to exemplary embodiments;

FIG. 9A illustrates a graph of a decomposition rate of a cleaning gas relative to a temperature when the cleaning gas was used in a cleaning method according to exemplary embodiments;

FIG. 9B illustrates a graph of a decomposition rate of a cleaning gas relative to a temperature when the cleaning gas was used in a cleaning method according to comparative examples;

FIG. 10 illustrates a graph of results of a comparison of cleaning efficiency between a cleaning method according to exemplary embodiments and a cleaning method according to a comparative example;

FIG. 11 illustrates a graph of results of a comparison of a cleaning time between a cleaning method according to exemplary embodiments and a cleaning method according to a comparative example;

FIG. 12 illustrates a block diagram of a memory card according to exemplary embodiments; and

FIG. 13 illustrates a block diagram of a memory system adopting a memory card according to exemplary embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

As used herein, the term “and/or” includes any and all combinations of one or more of the associated listed items. Expressions such as “at least one of”, when preceding a list of elements, modify the entire list of elements and do not modify the individual elements of the list. Like reference numerals in the drawings denote like elements, and thus descriptions thereof will be omitted.

It will be understood that, although the terms “first”, “second”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section.

Unless defined otherwise, all terms used herein including technical or scientific terms have the same meanings as those generally understood by those of skill in the art. The terms as those defined in generally used dictionaries are construed to have meanings matching that in the context of related technology and, unless clearly defined otherwise, are not construed to be ideally or excessively formal.

When some embodiments may be embodied otherwise, respective process operations described herein may be performed otherwise. For example, two process operations described in a sequential order may be performed substantially the same time or in reverse order.

Variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. When the term “substrate” is used in the present disclosure, it should be understood as either the substrate itself, or both the substrate and a stacked structure including a predetermined layer/film formed on a surface of the substrate. Also, when the expression “surface of the substrate” is used in the present disclosure, it should be understood as either an exposed surface of the substrate itself or an outer surface of a predetermined layer/film formed on the substrate.

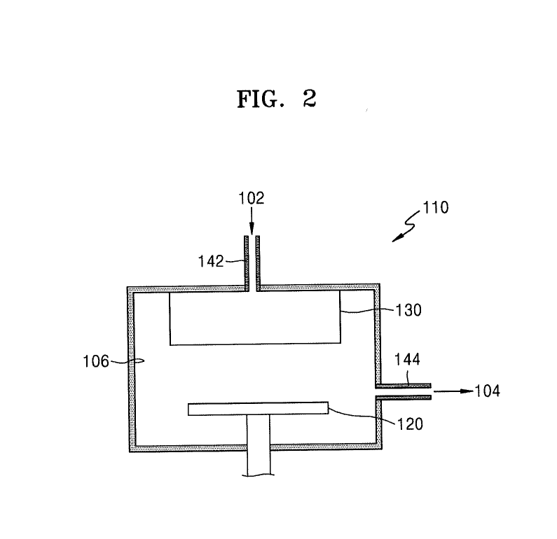

Figure illustrates is a flowchart of a cleaning method according to exemplary embodiments. FIG. 2 illustrates a schematic cross-sectional view of a chamber 110 to which a cleaning method may be applied, according to exemplary embodiments.

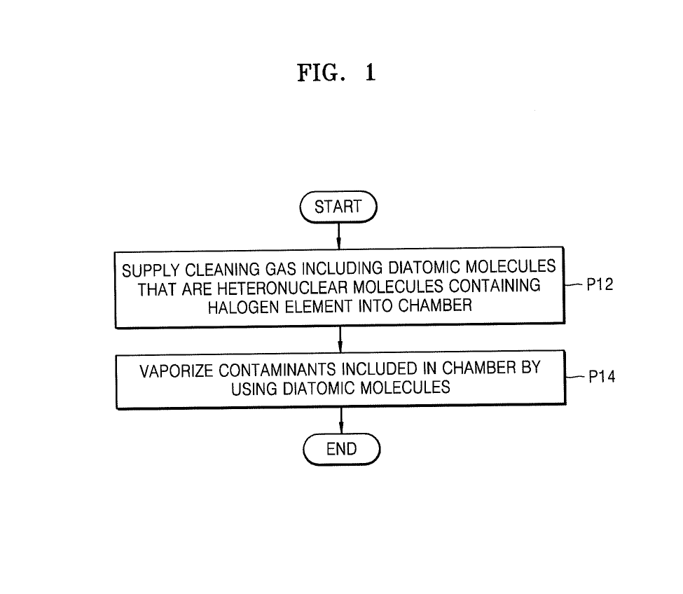

Referring to FIGS. 1 and 2, in process P12, a cleaning gas 102 including diatomic molecules that are heteronuclear molecules containing a halogen element may be supplied into a chamber 110 through a supply line 142. The cleaning gas 102 supplied into the chamber 110 may be sprayed to an inner space of the chamber 110 through a shower head 130.

Thereafter, a contaminant in the chamber 110 may be vaporized by using diatomic molecules contained in the cleaning gas 102 (process P14).

In some embodiments, the diatomic molecules contained in the cleaning gas 102 may be supplied into the chamber 110 while an inner temperature of the chamber 110 is maintained at a temperature of about 400° C. to about 1000° C.

In some embodiments, the diatomic molecules included in the cleaning gas 102 may include a first atom and a second atom selected from halogen elements, and bond energy between the first atom and the second atom may be at least 200 KJ/mol. As used herein, the term “bond energy” is defined as the amount of energy needed to break one mole of gas molecules into gas constituent atoms. For example, the diatomic molecules may be chlorine monofluoride (ClF) having one chlorine (Cl) atom and one fluorine (F) atom. ClF has a bond energy of about 247.2 KJ/mol. When a contaminant contained in a chamber is removed by means of a dry cleaning method using ClF gas as a cleaning gas, ClF gas may be ionized into ClF⁺ or ClF⁻ while Cl—F bonds are maintained, and the ionized ClF gas may react with the contaminant. Each of the Cl atom and the F atom of ClF may react with a contaminant remaining in the chamber to vaporize the contaminant.

The diatomic molecules included in the cleaning gas 102 supplied into the chamber 110 in the process P12 of FIG. 1 may be ClF.

To vaporize the contaminant in the chamber 110 by using the diatomic molecules included in the cleaning gas 102 in the process P14 of FIG. 1, while the cleaning gas 102 including the diatomic molecules is continuously being supplied into the chamber 110, a reaction resultant 104 obtained by a reaction of the diatomic molecules with the contaminant of the chamber 110 may be continuously discharged through an exhaust line 144 of the chamber 110.

In some embodiments, while the cleaning gas 102 is supplied into the chamber 110 according to the process P12 of FIG. 1 and the contaminant is vaporized by using the diatomic molecules included in the cleaning gas 102 according to the process P14 of FIG. 1, the diatomic molecules (e.g., ClF gas) included in the cleaning gas 102 may effectively remove the contaminant from the inside of the chamber 110 (e.g., from the inner wall 106 of the chamber 110) and/or constituent elements included in the chamber 110 (e.g., from a susceptor 120 for supporting a substrate).

A cleaning method according to exemplary embodiments may be performed by using a plasma-assisted cleaning process of applying plasma into the chamber 110 or a plasma-less cleaning process. In some embodiments, while a cleaning process is being performed in the chamber 110 according to exemplary embodiments, the cleaning gas 102 supplied into the chamber 110 may be excited by using high-frequency waves or microwaves. In some embodiments, the cleaning gas 102 may be excited outside the chamber 110 by using a remote plasma method, and excited radicals or ions may be supplied into the chamber 110 that is a cleaning target.

A chamber to which a cleaning method according to exemplary embodiments may be applied is shown in FIG. 2. In an embodiment, a chamber to which a cleaning method according to exemplary embodiments may be applied may be one of various types of chambers having various shapes. In some embodiments, a chamber to which a cleaning method according to exemplary embodiments may be a chamber used to manufacture various elements, such as a semiconductor chip, a solder cell, a flat panel display (FPD), and an organic light emitting diode (OLED). In some embodiments, the chamber to which the cleaning method according to the exemplary embodiments may be applied may be a chamber in which various deposition processes may be performed, for example, a deposition chamber included in a multi-chamber-type chemical vapor deposition (CVD) apparatus, a deposition chamber included in a batch-type CVD apparatus, a reaction chamber for performing an epitaxial deposition process, a deposition chamber for performing a physical vapor deposition (PVD) process, or a deposition chamber for performing an atomic layer deposition (ALD) process.

Reaction equation 1 shows a mechanism of a cleaning reaction that occurs when a titanium nitride (TiN) contaminant is removed at a temperature of about 600° C. by using ClF gas as a cleaning gas according to exemplary embodiments.

2TiN+4ClF→TiCl₄(↑)+TiF₄(↑)N₂(↑) (1)

As can be seen from Reaction equation 1, when a TiN contaminant is removed by using ClF as a cleaning gas, a Cl atom and an F atom of ClF gas may respectively react with titanium (Ti) to generate TiCl₄ gas and TiF₄ gas. The generated TiCl₄ gas and TiF₄ gas may be discharged through the exhaust line 144 out of the chamber 110.

To vaporize a contaminant contained in the chamber 110 by using diatomic molecules included in the cleaning gas 102 according to the process P14 of FIG. 1, the cleaning gas 102 including ClF gas may be continuously supplied into the chamber 110. Simultaneously, a reaction resultant (e.g., TiCl₄ gas and TiF₄ gas) 104 generated by a reaction of ClF gas with the contaminant contained in the chamber 110 may be continuously discharged through the exhaust line 144 of the chamber 110.

A process of cleaning the chamber may be performed by using ClF gas, all constituent elements of ClF may participate in a reaction for removing a contaminant to generate titanium-containing TiCl₄ gas and TiF₄ gas, and efficiency of removal of the contaminant may be increased.

In a cleaning process according to exemplary embodiments, the cleaning gas 102 supplied into the chamber 110 may include only diatomic molecules that are heteronuclear molecules containing a halogen element. In some embodiments, the cleaning gas 102 may include the diatomic molecules, and at least one gas selected out of, e.g., from, reactive gases containing molecules having a different chemical formula from the diatomic molecules, and inactive gases.

In some embodiments, the cleaning gas 102 may contain about 1 to 100% by volume diatomic molecules. For example, the cleaning gas 102 may contain about 1 to 100% by volume ClF gas. In some embodiments, the cleaning gas 102 may further include an inactive gas and/or an additional reactive gas. The inactive gas may include, for example, N₂, He, Ne, Ar, Kr, Xe, or a combination thereof. The inactive gas may be used as a carrier gas for transporting the diatomic molecules. The additional reactive gas may include a different component from diatomic molecules that are heteronuclear molecules containing a halogen element.

In some embodiments, the cleaning gas 102 may include a first reactive gas including diatomic molecules containing a first atom and a second atom, a second reactive gas including at least one of the first atom and the second atom and a molecule having a different chemical formula from the diatomic molecules, and an inactive gas. For example, the first reactive gas may include ClF, and the second reactive gas may include NF₃, SF₆, HCl, Cl₂, ClF₃, F₂N₂, CF₃Cl, Cl₂F₄, CF₄, C₂F₆, C₄F₆, C₄F₈, C₂ClF₃, F₂, or a combination thereof. The cleaning gas 102 may contain a higher concentration of the first reactive gas than the second reactive gas. For example, the second reactive gas may include diatomic molecules that are homonuclear molecules, for example, Cl₂, F₂, or a combination thereof.

In some embodiments, the cleaning gas 102 may include a first reactive gas including diatomic molecules containing a first atom and a second atom, a third reactive gas containing a third atom different from the first atom and the second atom, and an inactive gas. For example, the first reactive gas may include ClF, and the third reactive gas may include O₂, CO₂, CO, NO, NO₂, N₂O, H₂, CH₄, NH₃, HI, HBr, C₂H₂, or a combination thereof. The cleaning gas 102 may contain a higher concentration of the first reactive gas than the third reactive gas. For example, the third reactive gas may include diatomic molecules that are homonuclear molecules, for example, O₂, H₂, or a combination thereof.

In some embodiments, the cleaning gas 102 may include a first reactive gas including diatomic molecules containing a first atom and a second atom and a gas including a hydrocarbon compound, a fluorine-containing material, a chlorine-containing material, a nitrogen-containing material, an oxygen-containing material, an inactive gas, or a combination thereof. For example, the first reactive gas may include ClF. The hydrocarbon compound may include, for example, CH₄, C₂H₂, C₂H₆, or a combination thereof. The fluorine-containing material may include, for example, NF₃, SF₆, ClF₃, F₂N₂, CF₃Cl, Cl₂F₄, CF₄, C₂F₆, C₄F₆, C₄F₈, C₂ClF₃, F₂, or a combination thereof. The chlorine-containing material may be, for example, HCl. The nitrogen-containing material may include, for example, NO, NO₂, N₂O, NH₃, or a combination thereof. The oxygen-containing material may include, for example, O₂, CO₂, CO, NO, NO₂, N₂O, or a combination thereof. The inactive gas may include, for example, N₂, He, Ne, Ar, Kr, Xe, or a combination thereof.

Various contaminants may be removed by using a cleaning method according to exemplary embodiments. For example, the contaminant may include a metal-containing material, a nonmetallic material, or a semiconductor. In some embodiments, the contaminant may include Ti, Ta, Si, B, P, W, V, Nb, Se, Te, Mo, Re, Os, Ru, Ir, Sb, Ge, Au, Ag, As, Cr, oxides thereof, nitrides thereof, carbides thereof, or a combination thereof.

In a cleaning method according to an exemplary embodiment, a chamber to be cleaned, (e.g., the chamber 110 shown in FIG. 2) may include at least one constituent element including an aluminum-containing material. For example, the susceptor 120 may have an outer surface coated with aluminum nitride (AlN). In the process P12 of FIG. 1, when the cleaning gas 102 is supplied into the chamber 110, the cleaning gas 102 may be supplied to be in contact with at least one constituent element containing the aluminum-containing material. In the process P14 of FIG. 1, the diatomic molecules may react with a contaminant adsorbed to a surface of the at least one constituent element containing the aluminum-containing material in the chamber 110, and the contaminant may be vaporized to generate TiCl₄ gas and TiF₄ gas and the TiCl₄ gas and TiF₄ gas may be discharged through the exhaust line 144 out of the chamber 110. When the expression “surface of a constituent element” is used in the present disclosure, it should be understood as either an outer surface of the constituent element itself or an outer surface of a contaminant adsorbed onto the surface of the constituent element.

In the cleaning method according to exemplary embodiments, in a chamber to be cleaned (e.g., the chamber 110 shown in FIG. 2), the susceptor 120 having the outer surface coated with the MN may function as a heater. During the process (refer to P12 in FIG. 1) of supplying the cleaning gas 102 and the process (refer to P14 of FIG. 1) of vaporizing the contaminant, the susceptor 120 may be maintained at a first temperature selected from a range of about 400° C. to about 1000° C. The inner wall 106 of the chamber 110 may be maintained at a second temperature lower than the first temperature. For example, the inner wall 106 may be maintained at a temperature of about 150° C. to about 300° C. In the process P12 of FIG. 1, when the cleaning gas 102 is supplied into the chamber 110, the cleaning gas 102 may be supplied to contact each of the susceptor 120 and the inner wall 106. In the process P14 of FIG. 1, the diatomic molecules may react with a contaminant adsorbed to each of the susceptor 120 and the inner wall 106 in the chamber 110, and the contaminant may be vaporized to generate TiCl₄ gas and TiF₄ gas and the TiCl₄ gas and TiF₄ gas may be discharged through the exhaust line 144 out of the chamber 110.

Reaction mechanism 2 shows a mechanism of a cleaning reaction that occurs when a TiN contaminant is removed at a temperature of about 220° C. by using ClF₃ gas as a cleaning gas according to a comparative example.

2TiN+4ClF₃→2TiN+4ClF+4F₂

2TiN+4ClF+4F₂→2TiF₄(↑)⁴ClF(↑)+N₂(↑) (2)

As can be seen from Reaction mechanism 2, when TiN contaminant is removed by using ClF₃ gas as a cleaning gas, ClF₃ gas may be dissociated to generate F₂, and the generated F₂ may almost totally participate in a reaction for removing the contaminant to generate titanium-containing TiF₄ gas. When TiN contaminant is removed by using ClF₃ gas as a cleaning gas, CIF may be generated along with F₂ according to Reaction mechanism 2. However, since F₂ is highly reactive to TiN, ClF may hardly participate in a reaction with TiN. Accordingly, when ClF₃ gas is used as the cleaning gas, cleaning efficiency may be lower than when ClF gas is used as the cleaning gas.

ClF₃ gas may have relatively low thermal stability, and when ClF₃ gas is used as a cleaning gas to clean the inside of a chamber in which a thin film deposition process has been performed in a relatively high-temperature atmosphere of, for example, about 500° C. to about 700° C., directly after the thin film deposition process is performed in the chamber, a cleaning process may not be directly applied in-situ without an additional cooling process for dropping a temperature.

When a process of cleaning a chamber is performed by using ClF₃ gas as a cleaning gas at a relatively high temperature of, for example, about 500° C. to about 700° C. without letting an inner temperature of the chamber drop, a dissociation rate of ClF₃ gas may sharply increase due to, for example, low thermal stability thereof, and the amount of generation of fluorine may increase. The generated fluorine may be highly reactive to an aluminum-containing material (e.g., AlN) that is a constituent material of internal constituent elements, such as an inner wall of a chamber, a heater, or the susceptor 120 shown in FIG. 2, and undesired secondary byproducts, for example, aluminum-containing byproducts such as aluminum fluoride (AlFₓ) and aluminum oxide fluoride (AlOFₓ), may be generated. Aluminum fluoride may be adsorbed to the inner wall of the chamber or the inner constituent elements and contaminate the inside of the chamber. Removing aluminum fluoride from the inside of the chamber may not be easy, aluminum fluoride may act as a contamination source and result in several problems in an electronic device manufacturing process, and it may be difficult to use highly reactive ClF₃ gas in high-temperature atmospheres of about 500° C. to about 700° C.

In a cleaning method according to exemplary embodiments, diatomic molecules (e.g., CIF gas) having a relatively high bond energy of at least about 200 KJ/mol may be used as an etchant, thermal stability may be improved more than when F₂ having a relatively low bond energy of about 154.8 KJ/mol is used as an etchant, and generation of undesired secondary byproduct, such as AlFₓ and AlOFₓ, may be prevented.

By using the highly thermally stable gas, directly after a deposition process is performed in the chamber 110 at a relatively high temperature, for example, a temperature of about 500° C. to about 700° C., a cleaning process may be performed in-situ on the inside of the chamber 110 without breaking a vacuum in the chamber 110 while maintaining an inner temperature of the chamber 110 intact or allowing a minimum temperature variation, for example, only a temperature variation of about ±100° C.

When ClF₃ gas is used according to the comparative example with respect to Reaction mechanism 2, F₂ may act as an etchant for contaminants included in the chamber 110. In a cleaning method according to exemplary embodiments, diatomic molecules that are heteronuclear molecules including a halogen element may be used as the cleaning gas 102. Each of two constituent elements of the diatomic molecules may serve as an etchant for the contaminants included in the chamber 110, and the contaminants included in the chamber 110 may be effectively removed in a short period of time, and generation of undesired secondary byproducts may be inhibited during a cleaning process.

CIF gas having a relatively high bond energy of about 247.2 KJ/mol may be used as an etchant for removing contaminants from the chamber 110, the decomposition rate of ClF gas may become markedly low even at a high temperature due to, for example, excellent thermal stability of ClF gas, as compared with a case in which F₂ having a relatively low bond energy of about 154.8 KJ/mol is used as an etchant, and generation of undesired secondary byproducts, such as AlFₓ and AlOFₓ, may be prevented.

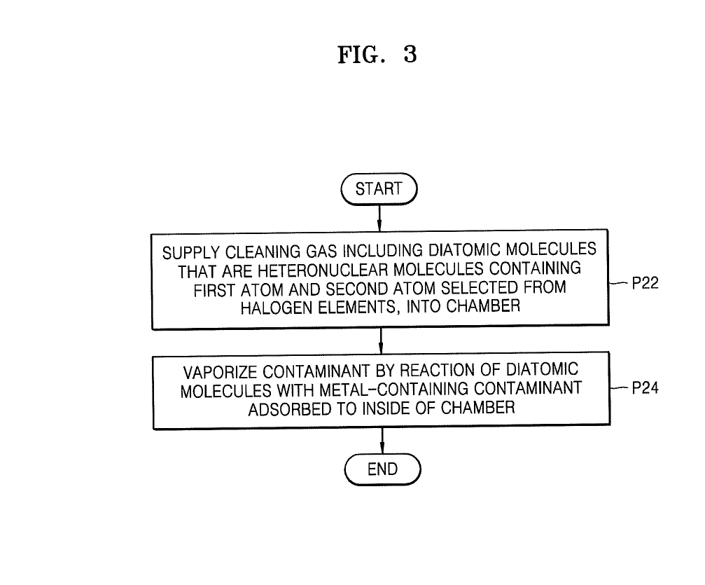

FIG. 3 illustrates a flowchart of a cleaning method according to other exemplary embodiments.

The cleaning method according to the other exemplary embodiments will now be described with reference to FIGS. 2 and 3.

In a process P22 of FIG. 3, a cleaning gas 102 including diatomic molecules that are heteronuclear molecules containing a first atom and a second atom that are selected from halogen elements may be supplied into a chamber 110.

Details of the cleaning gas 102 may be the same as those of the cleaning gas 102 described with reference to FIGS. 1 and 2.

In a process P24, a reaction of the diatomic molecules included in the cleaning gas 102 with a metal-containing contaminant adsorbed to the inside of the chamber 110 may be caused to vaporize the metal-containing contaminant.

An aluminum-containing constituent element may be contained in the chamber 110. For example, the chamber 110 may be formed of Al or an Al alloy. The susceptor 120 disposed in the chamber 110 may have an outer surface coated with AlN. In some embodiments, the susceptor 120 may further include a guide ring for guiding a substrate supported on the susceptor 120. The guide ring may be formed of Al₂O₃. In some embodiments, a plurality of support pins may be installed at the susceptor 120 and configured to support the substrate supported on the susceptor 120 to be capable of moving upward and downward. The plurality of support pins may be formed of Al₂O₃. The shower head 130 may include aluminum (Al) or an Al alloy. In another example, the shower head 130 may include nickel (Ni) or a Ni alloy.

A metal-containing contaminant inside of the chamber 110 may be adsorbed to a surface of at least one constituent element of the inner wall 106 of the chamber 110, the shower head 130, the susceptor 120, the guide ring included in the susceptor 120, and the plurality of support pins installed at the susceptor 120. Alternatively, the metal-containing contaminant may be adsorbed to an inner wall of the supply line 142 or an inner wall of an exhaust line 144.

The chamber 110 may be a chamber for, for example, forming a titanium (Ti) film or a titanium-containing film on the substrate while the substrate is placed on the susceptor 120, and the metal-containing contaminant adsorbed to the inside of the chamber 110 may include Ti. In an embodiment, the chamber 110 may be a chamber for depositing various materials, such as a metal, a metal nitride, a metal oxide, a nonmetallic material, and a semiconductor material, on a substrate. Accordingly, the contaminant adsorbed to the inside of the chamber 110 may include various elements, and the cleaning method according to the exemplary embodiments may be used to clean various kinds of chambers and remove various kinds of contaminants.

In process P24, to vaporize the metal-containing contaminant, the diatomic molecules included in the cleaning gas 102 may be supplied to surfaces of constituent elements included in the chamber 110.

While the cleaning gas 102 is being supplied into the chamber 110 according to the process P22 and the metal-containing contaminant is being vaporized according to the process P24, at least a portion of the inside of the chamber 110, for example, the susceptor 120, may be maintained at a temperature of about 400° C. to about 1000° C. Each of a process of supplying the cleaning gas 102 into the chamber 110 according to the process P22 and a process of vaporizing the metal-containing contaminant according to the process P24 may be performed while a substrate serving as a target on which a thin film is to be deposited is absent in the chamber 110.

Details of the cleaning gas 102 including the diatomic molecules are the same as described above with reference to FIGS. 1 and 2.

According to a cleaning method according to exemplary embodiments, aluminum-containing constituent elements may be disposed in the chamber 110, the inside of the chamber 110 may be dry cleaned by using the cleaning gas 102 containing diatomic molecules such as CIF, and a reaction of Al contained in the constituent elements of the chamber 110 with fluorine (F) may be inhibited and generation of undesired secondary byproducts, such as AlFₓ and AlOFₓ, may be inhibited. By using the cleaning gas 102 including diatomic molecules having excellent thermal stability, after a deposition process is performed in the chamber 110 at a relatively high temperature, a cleaning process may be performed in-situ in the chamber 210 directly after the deposition process without breaking a vacuum in the chamber 210 while maintaining an inner temperature of the chamber 210 intact or allowing a minimum temperature variation, for example, only a temperature variation of about ±100° C.

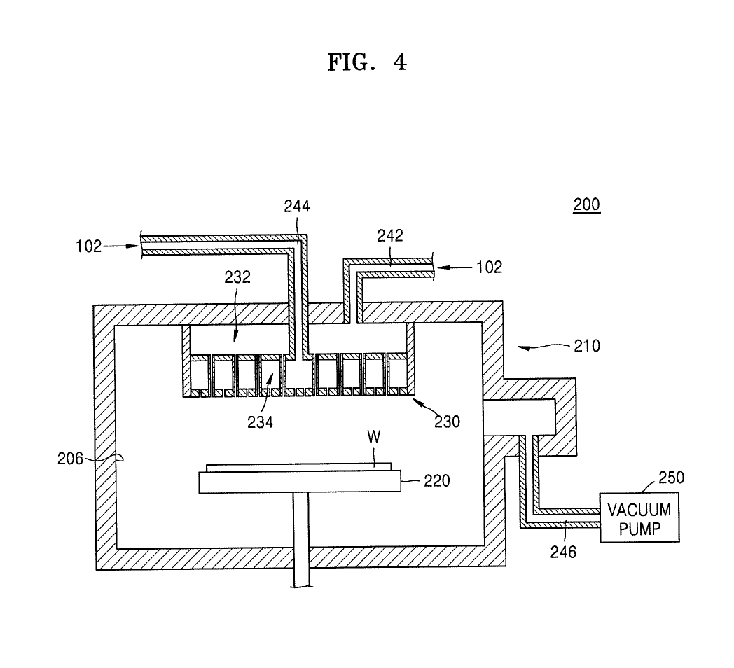

FIG. 4 illustrates a schematic diagram of a configuration of an electronic device manufacturing apparatus 200 to which a cleaning method may be applied, according to exemplary embodiments. FIG. 4 exemplarily illustrates the electronic device manufacturing apparatus 200 configured to form a thin film on a substrate by using a chemical vapor deposition (CVD) process.

Referring to FIG. 4, the electronic device manufacturing apparatus 200 may include a chamber 210, a susceptor 220 and a shower head 230 installed in the chamber 210, a first supply line 242 and a second supply line 244 configured to supply gases into the chamber 210, and an exhaust line 246 configured to externally discharge gases from the inside of the chamber 210. A substrate W may be mounted on the susceptor 220.

A heater may be installed in the susceptor 220, and the inside of the chamber 210 may be maintained at a decomposition temperature of a reactive gas or higher and the substrate W may be heated to a high temperature to facilitate deposition of reactive gases on the substrate W. The shower head 230 may spray reactive gases supplied into the chamber 210 downward toward the susceptor 220. A vacuum pump 250 may be connected to the exhaust line 246 to maintain the inside of the chamber 210 under a constant process pressure and externally discharge residues remaining after a deposition process.

The shower head 230 may include a first inlet unit 232 disposed at an upper portion thereof and a second inlet unit 234 disposed at a lower portion thereof. The first inlet unit 232 may be connected to the first supply line 242, and the second inlet unit 234 may be connected to the second supply line 244. Source gases required for forming a thin film may be supplied into the chamber 210 through the first supply line 242 and the second supply line 244 during a process of forming the thin film on the substrate W, and a cleaning gas 102 may be supplied into the chamber 210 through the first supply line 242 and the second supply line 244 during a cleaning process. For example, during the process of forming TiN thin film on the substrate W, a Ti source gas may be supplied into the chamber 210 through the first supply line 242 and the first inlet unit 232, and an N source gas may be supplied into the chamber 210 through the second supply line 244 and the second inlet unit 234, or vice versa. The Ti source gas may include TiCl₄, and the N source gas may include N₂.

While a TiN thin film is being formed on the substrate W in the chamber 210 of the electronic device manufacturing apparatus 200, a temperature of the susceptor 220 may be maintained at a temperature of about 400° C. to about 700° C. A temperature of the inside of the chamber 210 may be controlled by the temperature of the susceptor 220. When TiN thin film is formed on the substrate W to a desired thickness, the supplying of source gases may be interrupted, and source gases remaining in the chamber 210 may be discharged through the exhaust line 246 out of the chamber 210.

After the process of forming TiN thin film on the substrate W is performed on a predetermined number of substrates W in the above-described manner, the inside of the chamber 210 may be cleaned according to a cleaning method according to exemplary embodiments while the substrate W is absent in the chamber 210. Initially, after the substrate W is unloaded from the chamber 210, a dry cleaning process may be performed in-situ in the chamber 210 directly after the deposition process without breaking a vacuum in the chamber 210 while maintaining an inner temperature of the chamber 210 intact or allowing a minimum temperature variation, for example, only a temperature variation of about ±100° C. In some embodiments, during the process of cleaning the inside of the chamber 210, the susceptor 220 may be maintained at the same temperature as a temperature at which the susceptor 220 has been maintained during the process of forming a thin film on the substrate W. During the process of cleaning the inside of the chamber 210, a temperature of the inner wall 206 of the chamber 210 may be lower than a temperature of the susceptor 220. In some embodiments, the inside of the chamber 310 may be maintained under a pressure of, for example, about 0.1 torr to about 400 torr. Details of the cleaning process of the inside of the chamber 210 may be understood with reference to FIGS. 1 to 3.

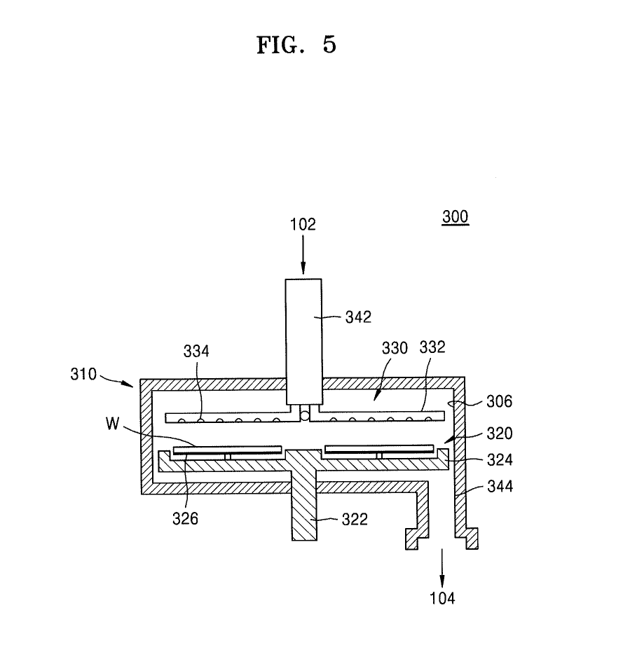

FIG. 5 illustrates a schematic diagram of a configuration of another electronic device manufacturing apparatus 300 to which a cleaning method may be applied, according to exemplary embodiments. FIG. 5 exemplarily illustrates an electronic device manufacturing apparatus 300 configured to form a thin film on the substrate W by using an atomic layer deposition (ALD) process.

Referring to FIG. 5, the electronic device manufacturing apparatus 300 may include a chamber 310 providing an airtight reaction space, a substrate stage 320 installed in the chamber 310 and configured to support a substrate W, a gas spray device 330 configured to spray a source gas, a reactive gas, and a purge gas required for forming a thin film into the chamber 310, a gas supply line 342 configured to supply a source gas, a reactive gas, and a purge gas to the gas spray device 330, and an exhaust line 344 configured to exhaust gases from the inside of the chamber 310.

The substrate stage 320 may include a shaft 322 capable of moving upward and downward, a main susceptor 324 connected to the shaft 322, and a plurality of sub-susceptors installed on the main susceptor 324 and configured to support the substrate W. While a thin film, forming process and a cleaning process are performed in the electronic device manufacturing apparatus 300, at least one of the gas spray device 330 and the substrate stage 320 may rotate. In some embodiments, the gas spray device 330 and the substrate stage 320 may rotate in opposite directions or in the same direction.

A plurality of gas sprayers 332 may be installed in the chamber 310 and respectively connected to the gas supply line 342. A plurality of gas spray holes 334 may be respectively formed in the plurality of gas sprayers 332 and opened toward the substrate stage 320. A plurality of substrates W may be placed on the substrate stage 320 and a source gas, a reactive gas, and a purge gas may be sprayed into the chamber 310 through the plurality of gas sprayers 332, and a desired thin film may be formed while sequentially supplying the source gas, the purge gas, and the reactive gas onto the substrate W due to, for example, the rotation of the gas spray device 330 or the substrate stage 320.

A metal-containing thin film may be formed on the substrate W in the chamber 310 of the electronic device manufacturing apparatus 300. For example, a TiAlN thin film may be formed on the substrate W, and TiCl₄ may be used as a Ti precursor, trimethylaluminum (TMA) may be used as an Al precursor, NH₃ may be used as a nitrogen source, and an inactive gas (e.g., argon (Ar)) or a non-reactive gas (e.g., nitrogen) may also be supplied into the chamber 310. The Ti precursor, the Al precursor, and the nitrogen source may be respectively supplied into the chamber 310 through different gas sprayers 332 of the plurality of gas sprayers 332. Specific examples of the Ti precursor, the Al precursor, and the nitrogen source may be selected from various materials.

To form the TiAlN thin film on the substrate W, initially, a Ti precursor (e.g., TiCl₄) may be sprayed onto the substrate W through one of the plurality of gas sprayers 332, and a purge gas may be sprayed through the plurality of gas sprayers 332. Thereafter, NH₃ that is a reactive gas may be sprayed onto the substrate W through another one of the plurality of gas sprayers 332, and a purge gas may be sprayed onto the substrate W through the plurality of gas sprayers 332. Thereafter, a Ti precursor (e.g., TMA) may be sprayed onto the substrate W through another one of the plurality of gas sprayers 332, and a purge gas may be sprayed onto the substrate W through the plurality of gas sprayers 332. NH₃ that is a reactive gas may be sprayed onto the substrate W through some of the plurality of gas sprayers 332, and a purge gas may be sprayed onto the substrate W through the plurality of gas sprayers 332.

A method of forming a thin film using an ALD process has been described above as an example. In an embodiment, a method of forming a thin film may be performed by using a physical vapor deposition (PVD) process, such as a sputtering process or a CVD process.

As described above, while a metal-containing thin film is formed on the substrate W in the chamber 310, a metal-containing contaminant, for example, a titanium-containing contaminant, may be adsorbed or deposited on an inner wall 306 of the chamber 310 and inner constituent elements of the chamber 310. After a process of forming a metal-containing thin film (e.g., a TiAlN thin film) on the substrate W is performed on a predetermined number of substrates W, to remove a metal-containing contaminant from the inside of the chamber 310, the inside of the chamber 310 may be dry cleaned according to a cleaning method according to exemplary embodiment while the substrate W is absent in the chamber 310. Initially, after the substrate W is unloaded from the chamber 310, a cleaning process may be performed in-situ in the chamber 310 directly after the deposition process without breaking a vacuum in the chamber 310 while maintaining an inner temperature of the chamber 310 intact or allowing a minimum temperature variation, for example, only a temperature variation of about ±100° C. During the cleaning process of the inside of the chamber 310, the cleaning gas 102 may be continuously supplied through the gas supply line 342, a reaction resultant 104 generated by a reaction of the cleaning gas 102 with a contaminant contained in the chamber 310 may be continuously discharged through the exhaust line 344 out of the chamber 310. In some embodiments, during the process of cleaning the inside of the chamber 310, the main susceptor 324 and the sub-susceptor 326 may be maintained at the same temperature as a temperature at which the main susceptor 324 and the sub-susceptor 326 have been maintained during the process of forming the metal-containing thin film on the substrate W. For example, during the process of cleaning the inside of the chamber 310, the main susceptor 324 and the sub-susceptor 326 may be maintained at a temperature of about 400° C. to about 1000° C., and the inside of the chamber 310 may be maintained under a pressure of about 0.1 torr to about 400 torr. During the process of cleaning the inside of the chamber 310, a temperature of the inner wall 306 of the chamber 310 may be lower than temperatures of the main susceptor 324 and the sub-susceptor 326. Details of the process of cleaning the inside of the chamber 310 will be understood with reference to FIGS. 1 to 3.

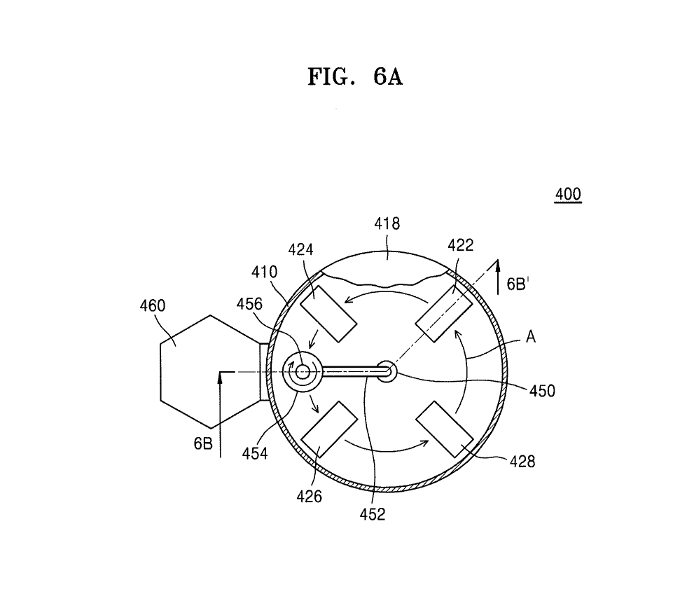

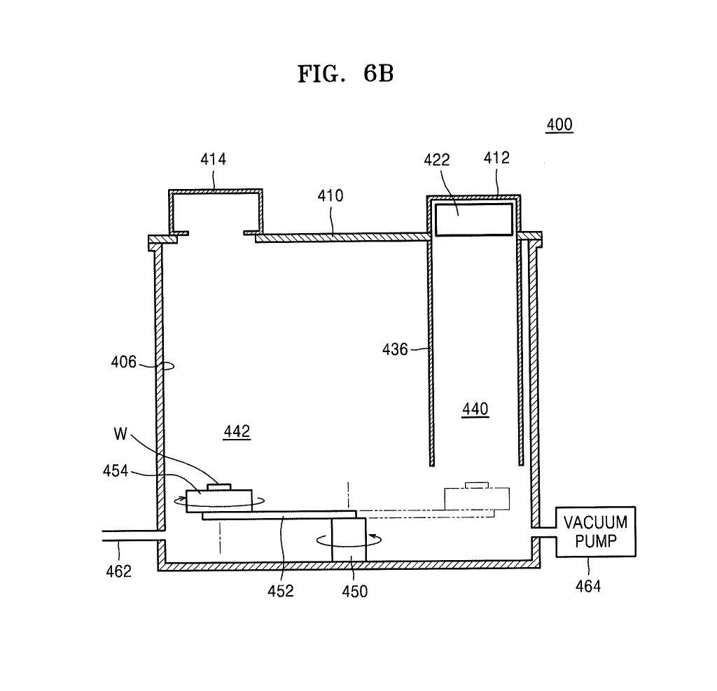

FIGS. 6A and 6B illustrate schematic diagrams of a configuration of another electronic device manufacturing apparatus 400 to which a cleaning method may be applied, according to exemplary embodiments. FIGS. 6A and 6B exemplarily illustrate an electronic device manufacturing apparatus 400 configured to form a thin film on a substrate by using a sputtering deposition process. FIG. 6B illustrates a cross-sectional view of essential parts, which is taken along a line 6B-6B′ of FIG. 6A.

Referring to FIGS. 6A and 6B, the electronic device manufacturing apparatus 400 may include a chamber 410 and a plurality of targets 422, 424, 426, and 428 included in the chamber 410. The plurality of targets 422, 424, 426, and 428 may be spaced apart from one another and exposed in the chamber 410 through a plurality of openings formed in a chamber cover 418. The present embodiment illustrates an example in which the electronic device manufacturing apparatus 400 includes four targets 422, 424, 426, and 428. In an embodiment, the electronic device manufacturing apparatus 400 may include four targets or fewer, e.g., three targets or fewer, or five targets or more. A plurality of targets 422, 424, 426, and 428 may be mounted in a container 412 disposed in an upper portion of the chamber 410.

A path unit 436 corresponding to each of the plurality of targets 422, 424, 426, and 428 may be connected to the upper portion of the chamber 410 including the plurality of targets 422, 424, 426, and 428 to guide a path of a material that is sputtered from each of the plurality of targets 422, 424, 426, and 428. A top entrance of the path unit 436 may face the corresponding target of the plurality of targets 422, 424, 426, and 428, and a bottom entrance of the path unit 436 may face a deposition region 440.

A rotary arm 452 capable of rotating about a first axis 450 and a substrate carrier 454 may be installed in the chamber 410 of the electronic device manufacturing apparatus 400. The substrate W may be supported on the substrate carrier 454 to be capable of rotating about a second axis 456. The substrate W may be loaded into the chamber 410 or unloaded from the chamber 410 through a loading/unloading unit 460.

The plurality of targets 422, 424, 426, and 428 may provide different sources for forming a thin film on the substrate W. In some embodiments, a multilayered metal-containing film may be formed by alternately stacking a first metal-containing and a second metal-containing film on the substrate W at least once. At least one of the first metal-containing film and the second metal-containing film may include Ti. To form the multilayered metal-containing film on the substrate W, the substrate carrier 454 for supporting the substrate W by using the rotary arm 452 may repetitively move to a first location under a first target 422 and a second location under a second target 424 while rotating in the direction of arrow A (refer to FIG. 6A). In some embodiments, a titanium-containing thin film including a single layer may be formed on the substrate W.

A gas inlet port 462 may be formed in the chamber 410 in a position adjacent to a process space 442. Gases, such as oxygen, nitrogen, and argon, may be supplied through the gas inlet port 462.

The chamber 410 may include an ion source 414 disposed on the chamber cover 418. The ion source 414 may emit energetic particle beams into the process space 442 of the chamber 410. The chamber 410 may be exhausted by a vacuum pump 464.

As described above, while a metal-containing thin film is being formed on the substrate W in the chamber 410, a metal-containing contaminant (e.g., a titanium-containing contaminant) may be adsorbed or deposited on an inner wall 406 of the chamber 410 and inner constituent elements of the chamber 410. Thus, after a process of forming a metal-containing thin film (e.g., a titanium-containing thin film) on the substrate W is performed on a predetermined number of substrates W, to remove a metal-containing contaminant included in the chamber 410, the inside of the chamber 410 may be cleaned according to a cleaning method according to exemplary embodiment while the substrate W is absent in the chamber 410. After the substrate W is unloaded from the chamber 410, a cleaning process may be performed in-situ on the inside of the chamber 410 directly after the deposition process while maintaining a reduced pressure without breaking a vacuum in the chamber 410 and while maintaining an inner temperature of the chamber 410 intact or allowing a minimum temperature variation, for example, only a temperature variation of about ±100° C. During the process of cleaning the inside of the chamber 410, the cleaning gas 102 may be continuously supplied through the gas inlet port 462, and a reaction result generated by a reaction of the cleaning gas 102 with a contaminant contained in the chamber 410 may be exhausted by the vacuum pump 464. In some embodiments, during the process of cleaning the inside of the chamber 410, the inside of the chamber 410 may be maintained at a temperature of about 400° C. to about 1000° C. under a pressure of about 0.1 torr to about 400 torr. Details of the process of cleaning the inside of the chamber 410 will be understood with reference to FIGS. 1 to 3.

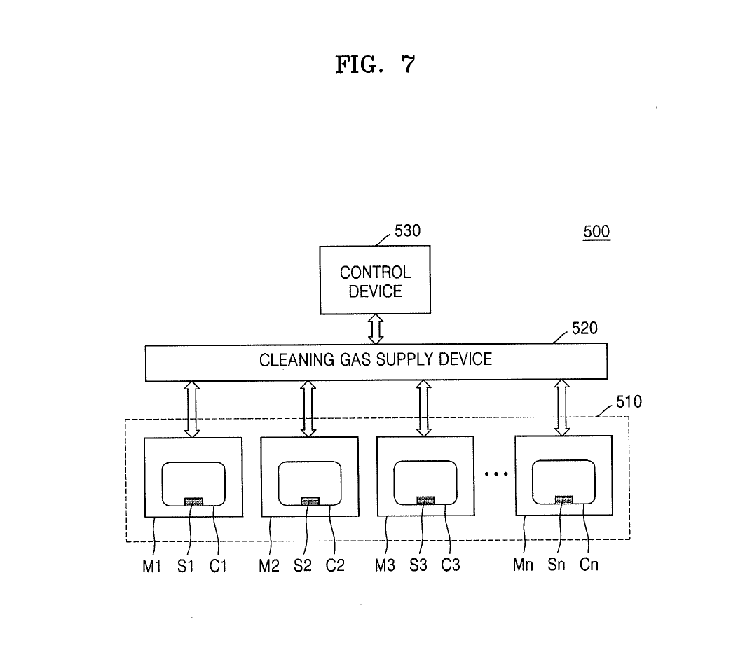

FIG. 7 illustrates a schematic diagram of a configuration of another electronic device manufacturing apparatus 500 to which a cleaning method may be applied, according to exemplary embodiments.

Referring to FIG. 7, the electronic device manufacturing apparatus 500 may include a process processing unit 510 including a plurality of process equipment M1, M2, M3, . . . , and Mn, a cleaning gas supply device 520 configured to supply the cleaning gas according to exemplary embodiments as described with reference to FIGS. 1 to 3 into each of chambers C1, C2, C3, . . . , and Cn included in the plurality of process equipment M1, M2, M3, . . . , and Mn, and a control device 530 configured to control a cleaning gas 102 to be selectively supplied into the chambers C1, C2, C3, . . . , and Cn included in the plurality of process equipment M1, M2, M3, . . . , and Mn.

The plurality of process equipment M1, M2, M3, . . . , and Mn included in the process processing unit 510 may include at least one of various apparatuses, such as a multi-chamber-type CVD apparatus, a deposition chamber included in a batch-type CVD apparatus, a reaction chamber for performing an epitaxial deposition process, a PVD apparatus, an ALD apparatus, an etching apparatus, a spin coating apparatus, a dry cleaning apparatus, or a wet cleaning apparatus. In some embodiments, the plurality of process equipment M1, M2, M3, . . . , and Mn may include at least one of the electronic device manufacturing apparatuses 200, 300, and 400 shown in FIGS. 4 to 6.

The cleaning gas 102 supplied from the cleaning gas supply device 510 may include diatomic molecules that are heteronuclear molecules including a first atom and a second atom selected from halogen elements. For example, the diatomic molecules included in the cleaning gas 102 may be CIF. Details of the cleaning gas 102 will be understood with reference to FIGS. 1 to 3.

The control device 530 may control the plurality of process equipment M1, M2, M3, . . . , and Mn to selectively supply the cleaning gas 102 from the cleaning gas supply device 520 to the chambers C1, C2, C3, . . . , and Cn of the plurality of process equipment M1, M2, M3, . . . , and Mn according to preset preventive maintenance (PM) cycles or in response to signals applied by contaminant sensors S1, S2, S3, . . . , and Sn installed in the chambers C1, C2, C3, . . . , and Cn of the plurality of process equipment M1, M2, M3, . . . , and Mn.

The inside of each of the chambers C1, C2, C3, . . . , and Cn of the plurality of process equipment M1, M2, M3, . . . , and Mn may be dry cleaned by using the cleaning gas 102 in response to a signal applied from the control device 520. Details of the dry etching process that may be performed by using the cleaning gas 102 in the chambers C1, C2, C3, . . . , and Cn will be understood with reference to FIGS. 1 to 3.

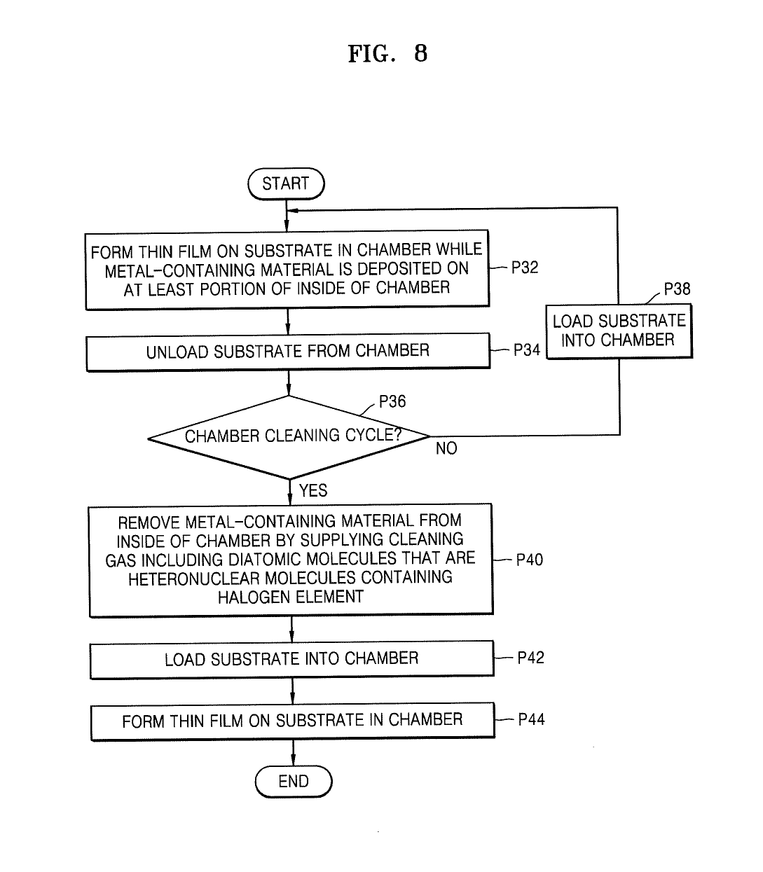

FIG. 8 illustrates a flowchart of a method of manufacturing an electronic device according to exemplary embodiments.

Referring to FIG. 8, in process P32, while a metal-containing material is being deposited in at least a portion of a chamber included in an electronic device manufacturing apparatus, a thin film may be formed on a substrate in the chamber.

In some embodiments, the electronic device manufacturing device used in the process P32 may be one of the electronic device manufacturing apparatus 200, 300, 400, and 500 shown in FIGS. 4 to 7. In some embodiments, the chamber used in the process P32 may be one of the chambers 210, 310, and 410 of the electronic device manufacturing apparatuses 200, 300, and 400 shown in FIGS. 4 to 6 or one of the chambers C1, C2, C3, . . . , and Cn included in the plurality of process equipment M1, M2, M3, . . . , and Mn shown in FIG. 7.

In some embodiments, in the process P32, a thin film, for example, formed of a metal, a metal nitride, a metal oxide, silicon oxide, silicon nitride, a semiconductor, and a combination thereof may be formed on the substrate.

To form the thin film on the substrate in the process P32, a CVD process, an ALD process, or a PVD process, for example, may be performed.

In process P34, the substrate on which the thin film is formed according to the process P32 may be unloaded from the chamber.

In process P36, it may be determined whether a chamber cleaning cycle has reached a predetermined chamber cleaning cycle. The chamber cleaning cycle may be set in various manners. For example, each time a thin film deposition process is performed on about 40 to 60 substrates, an operation of an electronic device manufacturing device for forming a thin film may be stopped, and the chamber may be cleaned.

When it is determined that the chamber cleaning cycle has not reached the predetermined chamber cleaning cycle yet in the process P36, a new substrate may be loaded into the chamber in process P38. Thereafter, a thin film forming process and an unloading process may be performed according to the processes P32 and P34.

When it is determined that the chamber cleaning cycle has reached the predetermined chamber cleaning cycle in the process P36, a chamber cleaning process may be performed according to process P40.

To perform the chamber cleaning process in the process P40, a cleaning gas including diatomic molecules that are heteronuclear molecules containing a halogen element may be supplied into the chamber to remove the metal-containing material from the inside of the chamber.

To remove the metal-containing material, the metal-containing material may be vaporized by a reaction of the diatomic molecules with the metal-containing material.

In some embodiments, in the process P32, a titanium-containing thin film may be formed on the substrate. To remove the metal-containing material according to process P40, a first reaction resultant may be generated by a reaction of a first atom constituting the diatomic molecules with titanium. A second reaction resultant may be generated by a reaction of a second atom constituting the diatomic molecules with titanium. Here, the first reaction resultant and the second reaction resultant may be simultaneously generated. For example, the cleaning gas may include ClF gas that is composed of the diatomic molecules. A reaction shown in Reaction equation 1 may occur between the diatomic molecules and the metal-containing material. A TiN contaminant may be removed by using ClF gas as a cleaning gas, TiCl₄ gas and TiF₄ gas may be respectively generated by causing a reaction of C1 atoms of ClF gas with titanium and a reaction of F atoms of CIF gas with titanium, and TiCl₄ gas and TiF₄ gas that are resultants vaporized according to Reaction equation 1 may be continuously discharged from the chamber.

In some embodiments, a reduced pressure may be maintained without breaking a vacuum state in the chamber during the process P32 of forming the thin film on the substrate, the process P34 of unloading the substrate, and the process P40 of removing the metal-containing material.

In some embodiments, the substrate may be maintained at a first temperature during the process P32 of forming the thin film on the substrate. During the process P40 of removing the metal-containing material, the cleaning gas may be supplied into the chamber while maintaining at least a portion of the inside of the chamber at the first temperature or a second temperature selected from a range of the first temperature ±100° C. For example, during the process P32 of forming the thin film on the substrate, at least a portion of the inside of the chamber may be maintained at a temperature of about 500° C. to about 700° C. Directly after the thin film forming process is finished, the metal-containing material may be removed by performing a cleaning process in-situ on the inside of the chamber without breaking a vacuum in the chamber while maintaining an inner temperature of the chamber intact or allowing a minimum temperature variation, for example, only a temperature variation of about ±100° C.

In some embodiments, the cleaning gas may include only ClF.

In some embodiments, the cleaning gas may include at least one gas of a first reactive gas formed of ClF, a second reactive gas containing molecules having a different chemical formula from the first reactive gas, and an inactive gas.

Details of the cleaning gas will be understood with reference to the cleaning gas 102 described with reference to FIGS. 1 to 3.

After a cleaning gas for removing a metal-containing material from the inside of the inside of the chamber is finished according to the process P40, a new substrate may be loaded into the inside of the chamber in process P42.

In process P44, a thin film may be formed on the substrate in the chamber. A process of forming the thin film on the substrate according to the process P44 may be performed in the same manner as in the process P32.

In the method of manufacturing the electronic device according to the exemplary embodiments, contaminants remaining in the chamber may be effectively removed in a short period of time without taking an additional temperature control time to perform a cleaning process directly after a deposition process, and time required to clean a chamber may be reduced and mass productivity, e.g., mass production, of deposition equipment may increase. A secondary byproduct may be inhibited from remaining in the chamber during the cleaning process, and cleaning efficiency may be improved and productivity, e.g., production, of an electronic device manufacturing process may be increased.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

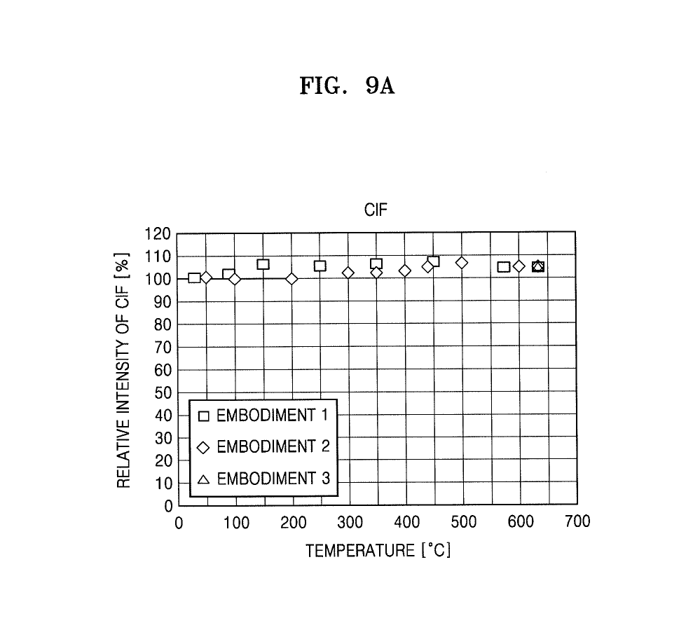

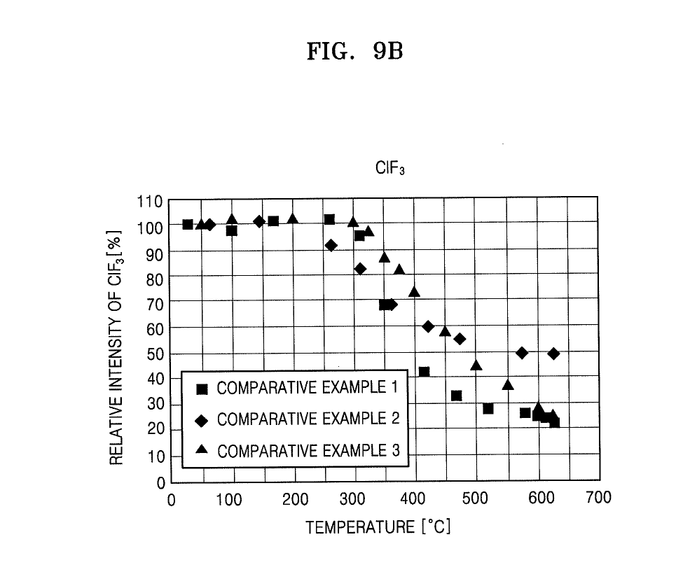

FIG. 9A illustrates a graph of a decomposition rate of ClF gas relative to a temperature when CIF gas was used as a cleaning gas used in a cleaning method according to exemplary embodiments.

In FIG. 9A, in each of a case (Example 1) in which a cleaning gas including 10% volume ClF gas and 90% by volume N₂ gas was used at a linear velocity of about 0.379 cm/s, a case (Example 2) in which a cleaning gas including 50% by volume ClF gas and 50% by volume N₂ gas was used at a linear velocity of about 0.079 cm/s, and a case (Example 3) in which a cleaning gas including 10% by volume ClF gas and 90% by volume N₂ gas was used at a linear velocity of about 0.228 cm/s, when a chamber in which a TiN deposition process had been performed was cleaned, a decomposition rate of ClF gas relative to a temperature of a susceptor included in the chamber was estimated by using a Fourier transform infrared (FTIR) analysis method.

From results of FIG. 9A, it was confirmed that even if a temperature of the susceptor was raised to a temperature of about 650° C. in the chamber, ClF gas was not pyrolyzed irrespective of a content of ClF in the cleaning gas. As can be seen from the estimation results of FIG. 9A, when a contaminant contained in the chamber is removed by cleaning the inside of the chamber by using a cleaning gas containing ClF gas, ClF gas may react with the contaminant while Cl—F bonds are maintained. For example, as can be seen from Reaction equation 1, when a TiN contaminant is removed by using ClF gas as the cleaning gas, ClF gas may be ionized into CIF+ or ClF− while Cl—F bonds are maintained, and a Cl atom and an F atom may respectively react with titanium to generate TiCl₄ gas and TiF₄ gas. The generated TiCl₄ gas and TiF₄ gas may be easily discharged from the chamber.

FIG. 9B illustrates a graph of a decomposition rate of ClF₃ gas relative to a temperature when a cleaning gas containing ClF₃ gas was used in a cleaning method according to comparative examples.

In FIG. 9B, in each of a case (Comparative Example 1) in which a cleaning gas including 10% by volume ClF₃ gas and 90% by volume N₂ gas was used at a linear velocity of about 0.379 cm/s, a case (Comparative Example 2) in which a cleaning gas including 50% by volume ClF₃ gas and 50% by volume N₂ gas was used at a linear velocity of about 0.079 cm/s, and a case (Comparative Example 3) in which a cleaning gas including 10% by volume ClF₃ gas and 90% by volume N₂ gas was used at a linear velocity of about 0.114 cm/s, when the inside of a chamber in which a TiN deposition process had been performed was cleaned, a decomposition rate of ClF₃ gas relative to a temperature of a susceptor included in the chamber was estimated by using an FTIR analysis method.

From results of FIG. 9B, it can be seen that ClF₃ gas was decomposed at a temperature of about 300° C. and a decomposition rate of ClF₃ gas became approximately constant at a temperature of about 600° C. It was confirmed that as a content of ClF₃ gas in the cleaning gas increased, the decomposition rate of ClF₃ gas was inhibited. From these results, it may be concluded that as the content of ClF₃ gas increased, ClF₃ gas and F₂ became easier to recombine. In the estimation results of FIG. 9B, it was revealed that a linear velocity hardly affected the decomposition rate of ClF₃ gas.

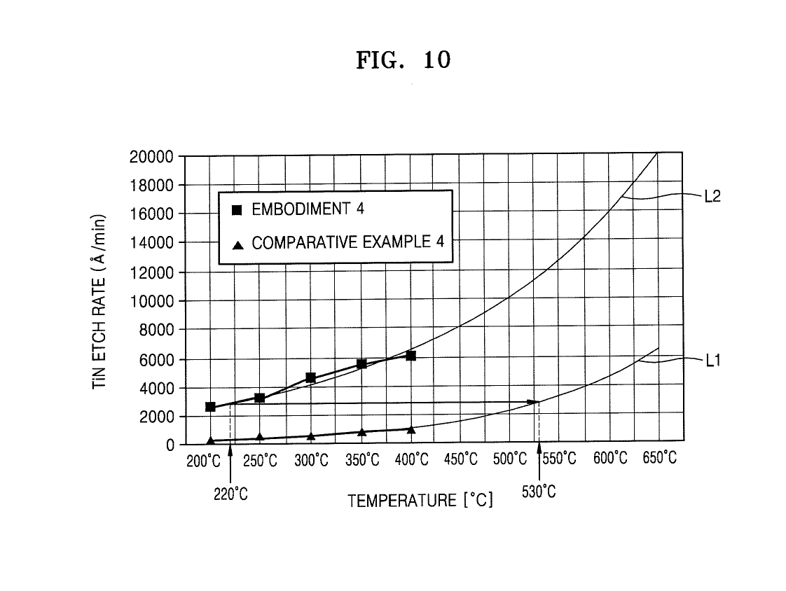

FIG. 10 illustrates a graph of results of a comparison of cleaning efficiency between a cleaning method according to exemplary embodiments and a cleaning method according to a comparative example.

In FIG. 10, Example 4 is a case in which the inside of a TiN thin film deposition chamber was cleaned by using a cleaning gas including CIF gas according to a cleaning method according to exemplary embodiments. FIG. 10 illustrates results of estimation of cleaning efficiency by an etch rate of a TiN thin film while varying a temperature of a susceptor disposed in the chamber from a temperature of about 200° C. to a temperature of about 400° C. during a cleaning process.

In FIG. 10, Comparative Example 4 is a case in which the inside of a TiN thin film deposition chamber was cleaned by using a cleaning gas including ClF₃ gas. FIG. 10 illustrates results of estimation of cleaning efficiency by an etch rate of a TiN thin film while varying a temperature of a susceptor disposed in the chamber from a temperature of about 200° C. to a temperature of about 400° C. during a cleaning process. In Example 4, a cleaning gas including 2% by volume CIF gas and 98% by volume N₂ gas was used. In Comparative Example 4, a cleaning gas including 2% by volume ClF₃ gas and 98% by volume N₂ gas was used. FIG. 10 illustrates both a trend line L1 of the etch rate of TiN thin film according to Example 4 and a trend line L2 of the etch rate of TiN thin film according to Comparative Example 4.

Referring to FIG. 10, in view of the trend line L1 of the etch rate of TiN thin film in the cleaning method according to Example 4, it was confirmed that the etch rate of TiN thin film obtained at a cleaning temperature of about 530° C. was maintained at an approximately similar level to the etch rate of TiN thin film obtained at a cleaning temperature of about 220° C.

As can be seen from the estimation results of FIG. 10, in the cleaning method according to the exemplary embodiments, even if a cleaning process is performed in a chamber at relatively high temperature that is close to a temperature at which a TiN thin film is formed, cleaning efficiency may be obtained at a similar level to cleaning efficiency obtained when a cleaning process is performed at a low temperature by using ClF₃ gas. Accordingly, before the cleaning process is performed in the chamber, an effective cleaning process may be performed without taking much time to perform an additional cooling process for lowering a temperature of the inside of the chamber.

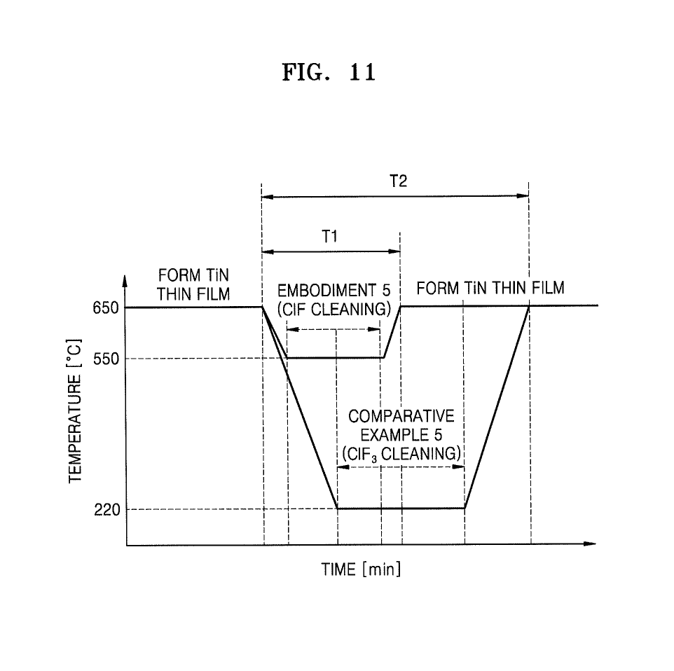

FIG. 11 illustrates a graph of results of a comparison of a cleaning time between a cleaning method according to exemplary embodiments and a cleaning method according to a comparative example.

In FIG. 11, in each of a case (Example 5) in which the inside of a TiN thin film deposition chamber is cleaned by using a cleaning gas including ClF gas based on a cleaning method according to exemplary embodiments and a case (Comparative Example 5) in which the inside of a TiN thin film deposition chamber is cleaned by using a cleaning gas including ClF₃ gas based on a cleaning method according to a comparative example, cleaning times were compared.

In Example 5, after a TiN thin film was formed by using a CVD process on a substrate loaded on a susceptor installed in a chamber while the susceptor was maintained at a temperature of about 650° C., the substrate was unloaded from the chamber. The inside of the chamber was cleaned by using a cleaning gas including about 2% by volume ClF gas and about 98% by weight N₂ gas while the susceptor was maintained at a temperature of about 550° C. In Example 5, after the substrate on which TiN thin film was formed was unloaded from the chamber, it took about 15 minutes to drop a temperature of the susceptor to a temperature of about 550° C. required for a cleaning process, and it took about 163 minutes to clean the inside of the chamber.

In Example 5, since F included in ClF gas has relatively low reactivity, a reaction of constituent elements, such as a susceptor including an aluminum-containing material (e.g., AlN), with OF gas was inhibited. Thus, it was confirmed that generation of secondary byproducts, for example, aluminum-containing byproducts such as AlFₓ and AlOFₓ, was inhibited.

In Comparative Example 5, the inside of a chamber was cleaned under the same condition as the chamber used in Example 5 by using a cleaning gas including about 2% by weight ClF₃ gas and about 98% by weight N₂ gas. In Comparative Example 5, since ClF₃ gas included in the cleaning gas had relatively low thermal stability, when a cleaning process was performed on the inside of the chamber in a high-temperature atmosphere of about 500° C. to about 700° C., a dissociation rate of ClF₃ gas sharply increased. Thus, the amount of generation of fluorine increased so that fluorine might react with internal constituent elements of the chamber, for example, internal constituent elements including an aluminum-containing material, to generate undesired secondary byproducts, for example, aluminum-containing byproducts, such as AlFₓ and AlOFₓ. Accordingly, when the inside of the chamber was cleaned by using a cleaning gas including ClF₃ gas, it was necessary to perform a cleaning process after the chamber stood by for a predetermined amount of time until a temperature of the inside of chamber was dropped to a temperature of about 200° C. to about 250° C. For the same reason as described above, in Comparative Example 5, after a TiN thin film was formed on a substrate loaded on a susceptor in the chamber including the susceptor maintained at a temperature of about 650° C., the substrate was unloaded from the chamber. After the chamber stood by until a temperature of the susceptor was dropped to a temperature of about 220° C., the inside of the chamber was cleaned by using a cleaning gas including about 2% by volume ClF₃ gas and about 98% by volume N₂ gas while the temperature of the susceptor was maintained at the temperature of about 220° C.

In Comparative Example 5, after the substrate on which TiN thin film was formed was unloaded from the chamber, it took about 126 minutes to drop the temperature of the susceptor to the temperature of about 220° C., and it took about 249 minutes to clean the inside of the chamber.

As can be seen from FIG. 11 that illustrates a comparison of Example 5 with Comparative Example 5, in the cleaning method according to the exemplary embodiments, a total time T1 that is consumed to drop a temperature to clean the chamber directly after a deposition process, to clean the chamber, and to raise a temperature to perform a subsequent thin film forming process was markedly reduced more than a total time T2 that is consumed according to Comparative Example 5.

As described above, in the cleaning method according to the exemplary embodiments, the time required to control a temperature of a chamber before and after a process of cleaning the chamber may be minimized, and contaminants remaining in the chamber may be effectively removed in a short period of time. Accordingly, the time required to clean the inside of the chamber may be reduced, and mass productivity, e.g., mass production, of deposition equipment may increase. Secondary byproducts may be prevented from remaining in the chamber during the cleaning process, and cleaning efficiency may be enhanced.

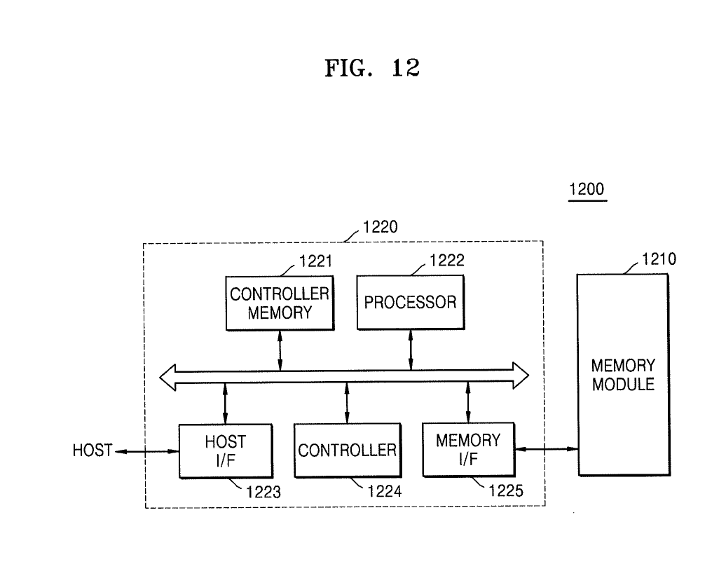

FIG. 12 illustrates a block diagram of a memory card 1200 according to exemplary embodiments.

Referring to FIG. 12, the memory card 1200 may include a memory controller 1220 configured to generate a command and an address signal C/A, and a memory module 1210, for example, a flash memory including one flash memory device or a plurality of flash memory devices. The memory controller 1220 may include a host interface 1223 configured to transmit a command and an address signal to a host or receive the command and the address signal from the host, and a memory interface 1225 configured to transmit the command and the address signal to the memory module 1210 again or receive the command and the address signal from the memory module 1210. The host interface 1223, a controller 1224, and a memory interface 1225 may communicate with a controller memory 1221 (e.g., a static random access memory (SRAM)) and a processor 1222 (e.g., a central processing unit (CPU)) through a common bus 1228.

The memory module 1210 may receive a command and an address signal from the memory controller 1220, store data in at least one of memory devices disposed on the memory module 1210 as a response, and search for data from at least one of the memory devices. Each of the memory devices may include a plurality of addressable memory cells, and a decoder configured to receive a command an address signal and generate a row signal and a column signal to access at least one of the addressable memory cells during program and read operations.

Each of constituent elements of the memory card 1200 including the memory controller 1220, electronic devices 1221, 1222, 1223, 1224, and 1225 included in the memory controller 1220 and the memory module 1210 may include at least one electronic device manufactured by using the cleaning method as described with reference to FIGS. 1 to 3 according to the exemplary embodiments and/or the method of manufacturing the electronic device as described with reference to FIG. 8 according to the exemplary embodiments.

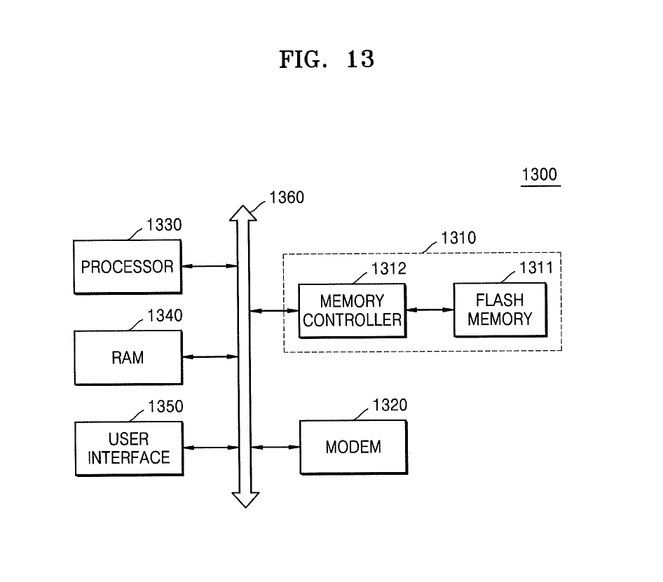

FIG. 13 illustrates a block diagram of a memory system 1300 adopting a memory card 1310 according to exemplary embodiments.

Referring to FIG. 13, the memory system 1300 may include a processor 1330 (e.g., a CPU) configured to perform communication operations through a common bus 1360, a random access memory 1340, a user interface 1350, and a modem 1320. The respective elements may transmit signals to the memory card 1310 through the common bus 1360 and receive signals from the memory card 1310. Each of constituent elements of the memory system 1300 including the processor 1330, the random access memory 1340, the user interface 1350, and the modem 1320 along with the memory card 1310 may include at least one electronic device manufactured by using a cleaning method according to exemplary embodiments as described with reference to FIGS. 1 to 3 and/or a method of manufacturing an electronic device according to exemplary embodiments as described with reference to FIG. 8.

The memory system 1300 may be applied in various fields of electronic applications, for example, solid-state drives (SSDs), complementary metal oxide semiconductor (CMOS) image sensors, and computer application chip sets.

Memory systems and devices described in the present disclosure may be packaged by using one of various device package types including, for example, ball grid arrays (BGAs), chip scale packages (CSPs), plastic leaded chip carriers (PLCCs), plastic dual in-line packages (PDIPs), multi-chip packages (MCPs), wafer-level fabricated packages (WFPs), and wafer-level processed stock packages (WSPs).

By way of summation and review, an in-situ dry cleaning process may not be directly performed at a Ti/TiN thin film deposition temperature of about 500° C. to about 700° C., but may be performed at a lower temperature of about 200° C. to about 300° C. ClF₃ gas may be used as a process gas during the in-situ dry cleaning process, and when ClF₃ gas is used at a temperature of about 500° C. to about 700° C., a dissociation rate of ClF₃ gas may sharply increase due to, for example, its low thermal stability, and the amount of generation of fluorine (F) may be increased. Thus, fluorine may become highly reactive to AlN in a chamber, and byproduct contaminants, such as AlFₓ, may be generated. Etch rates of Ti and TiN films may rapidly increase, and it may be impossible to control a process of cleaning the Ti and TiN films. Accordingly, an in-situ dry cleaning process may be performed at a reduced temperature of about 200° C. to about 250°.

Provided is an in-situ dry cleaning process that may use a Ti/TiN thin film deposition apparatus. To directly perform the in-situ dry cleaning process at a thin-film deposition temperature of about 500° C. to about 700° C., the in-situ dry cleaning process may be performed by using ClF gas that has higher thermal stability than ClF₃ gas and generates a smaller amount of fluorine than ClF₃ gas, and mass productivity of thin film deposition apparatuses may increase. From results of estimation of reactivity of AlN and Al₂O₃, it was confirmed that ClF may be less reactive to AlN and Al₂O₃ than ClF₃. Byproducts, such as AlFₓ, may not be generated even at a temperature of about 500° C. to about 700° C., and contamination of the inside of a chamber may be prevented.

Embodiments provide an electronic device manufacturing apparatus, which may effectively remove contaminants from the inside of a chamber in a short period of time during a cleaning process, and inhibit generation of an undesired secondary byproduct in the chamber during the cleaning process.

Embodiments also provide a cleaning method, which may effectively remove contaminants, which may be attendantly generated during a deposition process for forming a thin film on a substrate, from the inside of a chamber in a short period of time, and inhibit generation of an undesired secondary byproduct in the chamber during a cleaning process.

Embodiments also provide a method of manufacturing an electronic device, in which after a deposition process for forming a thin film on a substrate is performed, a cleaning process that may be capable of inhibiting generation of an undesired secondary byproduct may be performed while effectively removing contaminants, which may be generated in a chamber during the deposition process, in a short period of time. Thus, a time required for the cleaning process may be reduced, and mass productivity, e.g., mass production, of deposition equipment may increase, and productivity, e.g., production, of an electronic device manufacturing process may be improved.

Embodiments relate to an electronic device manufacturing apparatus including a chamber, a method of cleaning the inside of a chamber, and a method of manufacturing an electronic device by using the cleaning method.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

1.-10. (canceled)

11. A cleaning method, comprising:
supplying to an inside of a chamber a cleaning gas containing diatomic molecules that are heteronuclear molecules containing a halogen element; and
cleaning the inside of the chamber using the cleaning gas while the inside of the chamber is maintained at a temperature of about 400° C. to about 1000° C.

12. The method as claimed in claim 11, wherein the diatomic molecules include a first atom and a halogen element, and bond energy between the first atom and the halogen element is at least 200 KJ/mol.

13. The method as claimed in claim 11, wherein the diatomic molecules are chlorine monofluoride.

14. The method as claimed in claim 11, wherein cleaning the inside of the chamber includes supplying the diatomic molecules and at least one inactive gas into the chamber.

15. The method as claimed in claim 11, wherein the cleaning gas includes:
a first reactive gas including the diatomic molecules containing a first atom and a second atom;
a second reactive gas including molecules that contain at least one of the first atom and the second atom and have a different chemical formula from the diatomic molecules; and
an inactive gas.

16. The method as claimed in claim 11, wherein the cleaning gas includes:
a first reactive gas including the diatomic molecules containing a first atom and a second atom;
a second reactive gas including a third atom that is different from the first atom and the second atom; and
an inactive gas.

17. The method as claimed in claim 11, wherein the cleaning gas includes:
a first gas including the diatomic molecules; and
a second gas including a hydrocarbon compound, a fluorine-containing material, a chlorine-containing material, a nitrogen-containing material, an oxygen-containing material, an inactive gas, or a combination thereof.

18. The method as claimed in claim 11, wherein cleaning the inside of the chamber includes vaporizing a metal or a metal-containing material contained in the chamber, using the diatomic molecules.

19. The method as claimed in claim 11, wherein cleaning the inside of the chamber includes causing a reaction of the diatomic molecules with titanium or a titanium-containing material contained in the chamber.

20. The method as claimed in claim 11, wherein:
the diatomic molecules include a first atom and a halogen element, and
cleaning the inside of the chamber includes:
causing a reaction such that the first atom and the halogen element respectively combine with titanium or a titanium-containing material to vaporize titanium or the titanium-containing material.

21. The method as claimed in claim 11, wherein:
the chamber includes at least one constituent element containing an aluminum-containing material, and
cleaning the inside of the chamber includes bringing the diatomic molecules into contact with the at least one constituent element.

22. The method as claimed in claim 11, wherein:
a susceptor and an inner sidewall of the chamber are exposed in the chamber, and
cleaning the inside of the chamber includes bringing the diatomic molecules into contact with the susceptor and the inner sidewall of the chamber while the susceptor is maintained at a first temperature selected in the range of about 400° C. to about 1000° C. and the inner sidewall of the chamber is maintained at a second temperature lower than the first temperature.

23. A cleaning method, comprising:
supplying a cleaning gas including diatomic molecules that are heteronuclear molecules containing a first atom and a halogen element into a chamber; and
causing a reaction of the diatomic molecules with a metal-containing contaminant adsorbed to an inside of the chamber to vaporize the metal-containing contaminant.

24. The method as claimed in claim 23, wherein:
an aluminum-containing constituent element is contained in the chamber, and
vaporizing the metal-containing contaminant includes supplying the diatomic molecules to a surface of the constituent element.

25. The method as claimed in claim 23, wherein during supplying the cleaning gas into the chamber and vaporizing the metal-containing contaminant, at least a portion of the inside of the chamber is maintained at a temperature of about 400° C. to about 1000° C.

26. The method as claimed in claim 23, wherein:
the chamber includes a susceptor supporting a substrate in the chamber, and
the susceptor is maintained at a temperature of about 400° C. to about 1000° C. during supplying the cleaning gas into the chamber and vaporizing the metal-containing contaminant.

27. The method as claimed in claim 23, wherein the cleaning gas includes chlorine monofluoride.

28. The method as claimed in claim 23, wherein the cleaning gas includes chlorine monofluoride and an inactive gas.

29. The method as claimed in claim 23, wherein the cleaning gas includes:
chlorine monofluoride; and
at least one of a hydrocarbon compound, a fluorine-containing material, a chlorine-containing material, a nitrogen-containing material, an oxygen-containing material, or a combination thereof.

30. The method as claimed in claim 23, wherein the metal-containing contaminant includes titanium.

31.-42. (canceled)
